(19) United States
(12) Patent Application Publication
(10) Pub. No.: US 2012/0281700 A1
(43) Pub. Date: Nov. 8, 2012

(54) LAYER-3 SUPPORT IN TRILL NETWORKS

(75) Inventors: Phanidhar Koganti, Sunnyvale, CA (US); Anoop Ghanwani, Rocklin, CA (US); Suresh Vobbilisetty, San Jose, CA (US); Rajiv Krishnamurthy, San Jose, CA (US); Nagarajan Venkatesan, San Jose, CA (US); Shunjia Yu, San Jose, CA (US)

(73) Assignee: BROCADE COMMUNICATIONS SYSTEMS, INC., San Jose, CA (US)

(21) Appl. No.: 13/312,903

(22) Filed: Dec. 6, 2011

Related U.S. Application Data
(60) Provisional application No. 61/481,643, filed on May 2, 2011.
(60) Provisional application No. 61/503,265, filed on Jun. 30, 2011.

(51) Int. Cl. H04L 12/56

(52) U.S. Cl. 370/392

(57) ABSTRACT

One embodiment of the present invention provides a switch. The switch includes an IP header processor and a forwarding mechanism. The IP header processor identifies a destination IP address in a packet encapsulated with an inner Ethernet header, a TRILL header, and an outer Ethernet header. The forwarding mechanism determines an output port and constructs a new header for the packet based on the destination IP address. The switch also includes a packet processor which determines whether (1) an inner destination media access control (MAC) address corresponds to a local MAC address assigned to the switch; (2) a destination RBridge identifier corresponds to a local RBridge identifier assigned to the switch; and (3) an outer destination MAC address corresponds to the local MAC address.

### RELATED APPLICATIONS

This application claims the benefit of U.S. Provisional Application No. 61/481,643, Attorney Docket Number BRCD-3093.0.1.US.PSP, titled “Layer-3 Support in Virtual Cluster Switching,” by inventors Phanidhar Koganti, Anoop Ghanwani, Suresh Vobbilisetty, Rajiv Krishnamurthy, Nagarajan Venkatesan, and Shunjia Yu, filed 2 May 2011, and U.S. Provisional Application No. 61/503,265, Attorney Docket Number BRCD-3093.0.2.US.PSP, titled “IP Routing in VCS,” by inventors Phanidhar Koganti, Anoop Ghanwani, Suresh Vobbilisetty, Rajiv Krishnamurthy, Nagarajan Venkatesan, and Shunjia Yu, filed 30 Jun. 2011, which are incorporated by reference herein.

The present disclosure is related to U.S. patent application Ser. No. 13/087,239, (attorney docket number BRCD-3008.1.US.NP), titled “Virtual Cluster Switching,” by inventors Suresh Vobbilisetty and Dilip Chatwani, filed 14 Apr. 2011, and U.S. patent application Ser. No. 12/725,249, (attorney docket number BRCD-112-0439US), titled “Redundant Host Connection in a Routed Network,” by inventors Somesh Gupta, Anoop Ghawani, Phanidhar Koganti, and Shunjia Yu, filed 16 Mar. 2010, the disclosures of which are incorporated by reference herein.

### BACKGROUND

1. Field

The present disclosure relates to network design. More specifically, the present disclosure relates to a method and system for constructing a scalable switching system that supports layer-3 routing while facilitating automatic configuration.

2. Related Art

The growth of the Internet has brought with it an increasing demand for bandwidth. As a result, equipment vendors race to build larger and faster switches with versatile capabilities, such as layer-3 forwarding, to move more traffic efficiently. However, the size of a switch cannot grow infinitely. It is limited by physical space, power consumption, and design complexity, to name a few factors. Furthermore, switches with higher capability are usually more complex and expensive. More importantly, because an overly large and complex system often does not provide economy of scale, simply increasing the size and capability of a switch may prove economically unviable due to the increased per-port cost.

One way to increase the throughput of a switch system is to use switch stacking. In switch stacking, multiple smaller-scale, identical switches are interconnected in a special pattern to form a larger logical switch. The amount of required manual configuration and topological limitations for switch stacking becomes prohibitively tedious when the stack reaches a certain size, which precludes switch stacking from being a practical option in building a large-scale switching system.

Meanwhile, layer-2 (e.g., Ethernet) switching technologies continue to evolve. More routing-like functionalities, which have traditionally been the characteristics of layer-3 (e.g., Internet Protocol or IP) networks, are migrating into layer-2. Notably, the recent development of the Transparent Interconnection of Lots of Links (TRILL) protocol allows Ethernet switches to function more like routing devices. TRILL overcomes the inherent inefficiency of the conventional spanning tree protocol, which forces layer-2 switches to be coupled in a logical spanning-tree topology to avoid looping. TRILL allows routing bridges (RBridges) to be coupled in an arbitrary topology without the risk of looping by implementing routing functions in switches and including a hop count in the TRILL header.

While TRILL brings many desirable features to layer-2 networks, some issues remain unsolved when layer-3 processing is desired.

### SUMMARY

One embodiment of the present invention provides a switch. The switch includes an IP header processor and a forwarding mechanism. The IP header processor identifies a destination IP address in a packet encapsulated with an inner Ethernet header, a TRILL header, and an outer Ethernet header. The forwarding mechanism determines an output port and constructs a new header for the packet based on the destination IP address. The switch also includes a packet processor which determines whether (1) an inner destination media access control (MAC) address corresponds to a local MAC address assigned to the switch; (2) a destination RBridge identifier (RBridge ID) corresponds to a local RBridge identifier assigned to the switch; and (3) an outer destination MAC address corresponds to the local MAC address.

In a variation on this embodiment, the packet processor determines a first virtual local area network (VLAN) tag in the inner Ethernet header, wherein the new header includes a new inner Ethernet header which comprises a second VLAN tag.

In a variation on this embodiment, the switch includes a control mechanism which forms a virtual cluster switch in conjunction with one or more additional switches.

In a variation on this embodiment, the virtual cluster switch is an Ethernet fabric switch functioning as a logical Ethernet switch.

In a variation on this embodiment, the switch includes a switching mechanism switches the packet between VLANs based on the destination IP address.

In a variation on this embodiment, the RBridge identifier is a virtual RBridge identifier and the destination IP address is a virtual IP address assigned to a virtual IP router associated with the virtual RBridge identifier.

In a variation on this embodiment, the virtual IP router is formed by operating the switch in conjunction with at least another physical switch as a single logical router.

### BRIEF DESCRIPTION OF THE FIGURES

FIG. 1 illustrates an exemplary TRILL network that includes a plurality of RBridges with IP processing capabilities, in accordance with an embodiment of the present invention.

FIG. 2A illustrates an exemplary configuration of end devices belonging to different VLANs and coupled to a TRILL network, wherein one RBridge is IP capable, in accordance with an embodiment of the present invention.

FIG. 2B illustrates an exemplary configuration of end devices belonging to different VLANs and coupled to a TRILL network, wherein all RBridges are IP capable, in accordance with an embodiment of the present invention.

FIG. 3A illustrates an exemplary TRILL network with multiple VLANs, in accordance with an embodiment of the present invention.

FIG. 3B illustrates an exemplary TRILL network with multiple VLANs, wherein each RBridge belongs to all VLANs, in accordance with an embodiment of the present invention.

FIG. 4A presents a flowchart illustrating the process of an RBridge transmitting a frame, in accordance with an embodiment of the present invention.

FIG. 4B presents a flowchart illustrating the process of an IP-capable RBridge transmitting a frame, in accordance with an embodiment of the present invention.

FIG. 5 illustrates an exemplary network where a virtual RBridge and an associated virtual IP router are created based on a plurality of physical gateway RBridges with IP processing capabilities, in accordance with an embodiment of the present invention.

FIG. 6A illustrates an exemplary configuration of how a virtual RBridge and an associated virtual IP router can be logically coupled to a number of gateway RBridges in a TRILL network, in accordance with an embodiment of the present invention.

FIG. 6B illustrates an exemplary configuration of how a virtual RBridge and an associated virtual IP router can be logically coupled to all RBridges in a TRILL network where each RBridge has IP processing capability, in accordance with an embodiment of the present invention.

FIG. 7A presents a flowchart illustrating the process of a gateway RBridge associated with a virtual RBridge responding to an Address Resolution Protocol (ARP) query, in accordance with an embodiment of the present invention.

FIG. 7B presents a flowchart illustrating the process of a gateway RBridge associated with a virtual RBridge forwarding a TRILL frame, in accordance with an embodiment of the present invention.

FIG. 8 illustrates a scenario where one of the RBridges associated with the virtual RBridge experiences a link failure and/or a node failure, in accordance with an embodiment of the present invention.

FIG. 9 illustrates an exemplary architecture of a switch with IP processing capabilities, in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

### Overview

In embodiments of the present invention, the problem of providing scalable and flexible layer-3 (e.g., IP) support in a TRILL network is solved by facilitating IP routing in a number of RBridges in the TRILL network. The availability of IP processing within a TRILL network allows cross-layer-2-domain traffic (e.g., traffic across different VLANs) to be forwarded within a TRILL network, which reduces forwarding overhead. Usually, the IP router portion of one of these IP-capable RBridges is assigned as a default gateway router to an end device coupled to a TRILL network. Wherever the end device sends a frame to outside of its local network (e.g., a VLAN), the frame is forwarded to and processed by the IP router portion of the RBridge. This layer-3 processing occurs within the TRILL network. Note that, in a conventional TRILL network, such layer-3 processing has to be done by an IP router residing outside the TRILL network.

In some embodiments, the end-device may be coupled to the TRILL network via an ingress RBridge without IP processing capability. Under such a scenario, the TRILL RBridge portion of an IP-capable RBridge acts as an egress RBridge and the IP router portion of the RBridge can act as the default gateway router. A frame from the end device is received at the ingress RBridge and encapsulated in a TRILL packet, wherein the TRILL packet sets the egress RBridge identifier as the destination RBridge identifier, and the MAC address of the egress RBridge as the inner destination MAC address. The packet is then forwarded though the TRILL network and reaches the egress RBridge, where the outer destination MAC address of the packet is the MAC address of the egress RBridge. The IP router portion of the egress RBridge then processes the IP header in the frame and makes the layer-3 forwarding decision based on the destination IP address of the frame.

In some embodiments, the IP router portion of an IP-capable RBridge may be associated with multiple VLANs associated with the TRILL network. If the destination end device of the frame belongs to one of the associated VLANs, the IP router can obtain the MAC address of the destination end device using ARP requests within that VLAN. The corresponding RBridge of the IP router then sets the RBridge to which the destination end device is coupled as the egress RBridge and forwards the frame to the egress RBridge over the TRILL network.

Although the present disclosure is presented using examples based on the TRILL protocol, embodiments of the present invention are not limited to TRILL networks, or networks defined in a particular Open System Interconnection Reference Model (OSI reference model) layer.

The term “RBridge” refers to routing bridges, which are bridges implementing the TRILL protocol as described in IETF Request for Comments (RFC) “Routing Bridges (RBridges): Base Protocol Specification,” available at http://tools.ietf.org/html/rfc6325, which is incorporated by reference herein. Embodiments of the present invention are not limited to applications among RBridges. Other types of switches, routers, and forwarders can also be used.

In this disclosure, the term “edge port” refers to a port which sends/receives data frames in native Ethernet format. The term “TRILL port” refers to a port which sends/receives data frames encapsulated with a TRILL header and outer MAC header.

The term “end device” refers to a network device that is typically not TRILL-capable. “End device” is a relative term with respect to the TRILL network. However, “end device” does not necessarily mean that the network device is an end host. An end device can be a host, a conventional layer-2 switch, or any other type of network device. Additionally, an end device can be coupled to other switches or hosts further away from the TRILL network. In other words, an end device can be an aggregation point for a number of network devices to enter the TRILL network.

The term “IP-capable RBridge” refers to a physical RBridge that can process and route IP packets. An IP-capable RBridge can be coupled to a layer-3 network and can forward IP packets from end devices to the layer-3 network. A number of IP-capable RBridges can form a virtual RBridge and a corresponding virtual IP router, thereby facilitating a virtual gateway router for end devices that supports redundancy and load-balancing. In this disclosure, an RBridge which forms a virtual RBridge and a virtual IP router is also referred to as a “gateway” RBridge. A gateway RBridge responds to ARP requests for the virtual IP address with a virtual MAC address. In various embodiments, any arbitrary number of gateway RBridges can form the virtual RBridge. As gateway RBridges can process both TRILL and IP packets, in this disclosure the term “gateway RBridge” can refer to a physical RBridge in a TRILL network or a physical router in an IP network.

The term “IP router” refers to the IP-capable portion of an RBridge or a stand-alone IP router. In this disclosure, the terms “IP router” and “router” are used interchangeably.

The term “frame” refers to a group of bits that can be transported together across a network. “Frame” should not be interpreted as limiting embodiments of the present invention to layer-2 networks. “Frame” can be replaced by other terminologies referring to a group of bits, such as “packet,” “cell,” or “datagram.”

The term “RBridge identifier” refers to a group of bits that can be used to identify an RBridge. Note that the TRILL standard uses “RBridge ID” to denote a 48-bit intermediate-system-to-intermediate-system (IS-IS) System ID assigned to an RBridge, and “RBridge nickname” to denote a 16-bit value that serves as an abbreviation for the “RBridge ID.” In this disclosure, “RBridge identifier” is used as a generic term and is not limited to any bit format, and can refer to “RBridge ID” or “RBridge nickname” or any other format that can identify an RBridge.

### Network Architecture

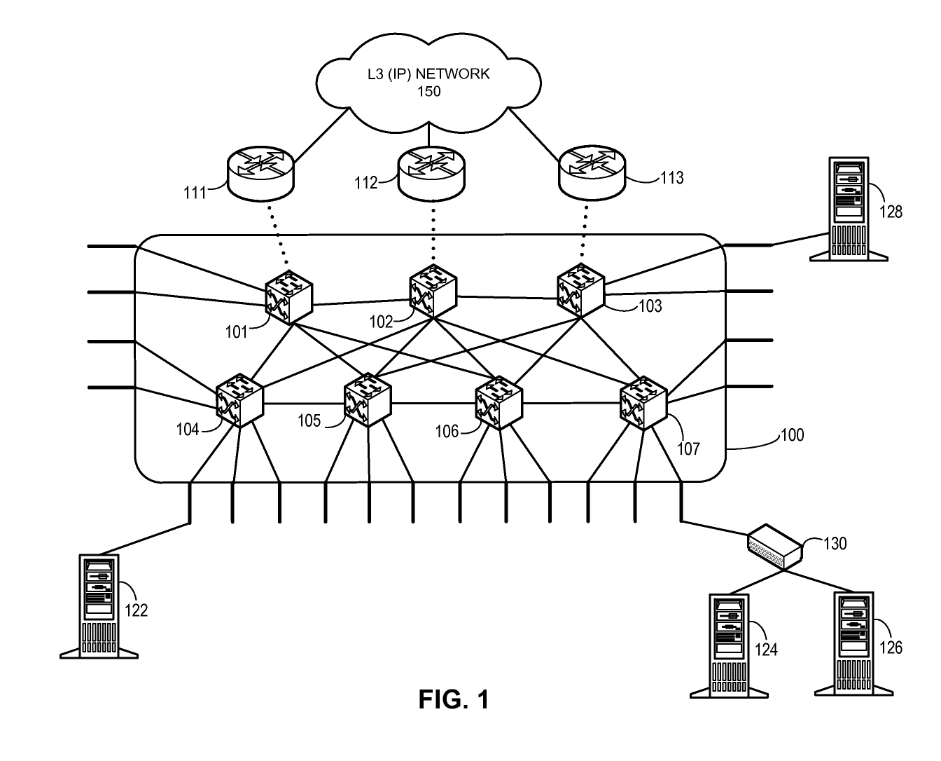

FIG. 1 illustrates an exemplary TRILL network that includes a plurality of RBridges with IP processing capabilities, in accordance with an embodiment of the present invention. As illustrated in FIG. 1, a TRILL network 100 includes RBridges, 101, 102, 103, 104, 105, 106, and 107. RBridges 101, 102, and 103 are IP capable and coupled to a layer-3 network 150 as IP routers, 111, 112, and 113, respectively. For example, RBridge 101 and IP router 111 are the same physical device (represented by dotted lines), where its TRILL RBridge portion is denoted by RBridges 101 and its IP router portion is denoted by router 111. Similarly, RBridge 102 and IP router 112, and RBridge 103 and IP router 113, are the same physical devices, respectively.

RBridges in network 100 use edge ports to communicate to end devices and TRILL ports to communicate to other RBridges. For example, RBridge 104 is coupled to end device 122 via an edge port and to RBridges 105, 101, and 102 via TRILL ports. An end host coupled to an edge port may be a host machine or an aggregation node. For example, end devices 122, 124, 126, and 128 are host machines, wherein end devices 122 and 128 are directly coupled to network 100, and end devices 124 and 126 are coupled to network 100 via their aggregation node, a layer-2 bridge 130.

In FIG. 1, end device 128 is directly coupled to RBridge 103. Hence, IP router 113 can act as the default gateway for end device 128. Consequently, all frames from end device 128 destined to IP network 150 are received at IP router 113 and forwarded to network 150. On the other hand, RBridge 104 couples end device 122 to network 100 and acts as the ingress RBridge for all frames from end device 122. One of the IP-capable RBridges (e.g., RBridge 101) acts as the egress RBridge for frames from end device 122 to network 150. Under such a scenario, the frame destined to network 150 is encapsulated in a TRILL packet with the RBridge identifier of RBridge 101 as the destination RBridge identifier, and the MAC address of RBridge 101 as the inner destination MAC address. The TRILL packet is then forwarded to RBridge 101, where the outer destination MAC address of the packet is the MAC address of RBridge 101. IP router 111 then processes the IP header in the frame and makes the layer-3 forwarding decision based on the destination IP address of the frame.

During operation that does not involve layer-3 processing in RBridges, an end device coupled to the TRILL network may select the default gateway from a layer-3 network and use the corresponding IP address as a default gateway router address. For example, in FIG. 1, end device 128 selects the default gateway router from IP network 150. Any frame destined to network 150 from end device 128 is sent to the default gateway. Under such a scenario, if end devices 122 and 128 are on different VLANs, any communication between these end devices will go through network 150. If end device 128 sends a frame to end device 122, the frame first goes to the default gateway in network 150. Consequently, the default gateway processes the IP header in the frame and makes layer-3 forwarding decision toward end device 122. As a result, routing and bandwidth management will be inefficient and the frame will incur higher latency.

In embodiments of the present invention, as illustrated in FIG. 1, each frame destined to end device 122 from end device 128, wherein the end devices are on different VLANs, is received at RBridge 103. IP router 113 processes the IP header in the frame and makes the forwarding decision toward end device 122 (which involves forwarding the frame on end device 122's VLAN through TRILL network 100). Consequently, RBridge 103 forwards the frame to a corresponding egress RBridge 104 over TRILL network 100. RBridge 104, in turn, transmits the frame to end device 122. Hence, enabling layer-3 support on RBridges in a TRILL network provides higher efficiency in routing and bandwidth management.

In some embodiments, the TRILL network may be a virtual cluster switch (VCS). In a VCS, any number of RBridges in any arbitrary topology may logically operate as a single switch. Any new RBridge may join or leave the VCS in “plug-and-play” mode without any manual configuration.

Note that TRILL is only used as a transport between the switches within network 100. This is because TRILL can readily accommodate native Ethernet frames. Also, the TRILL standards provide a ready-to-use forwarding mechanism that can be used in any routed network with arbitrary topology. Embodiments of the present invention should not be limited to using only TRILL as the transport. Other protocols (such as multi-protocol label switching (MPLS)), either public or proprietary, can also be used for the transport.

### Routine Across VLANs

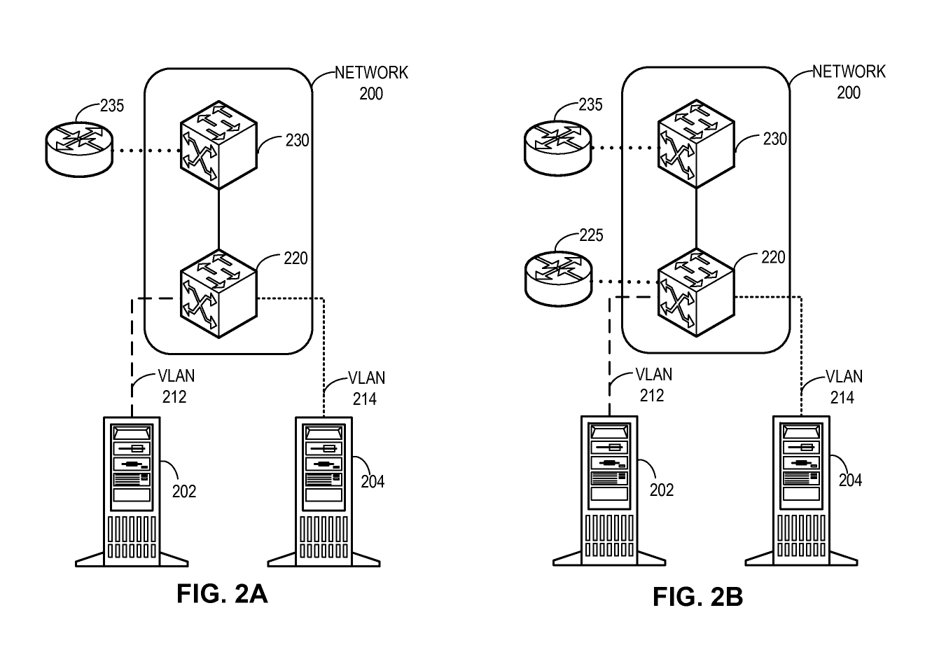

FIG. 2A illustrates an exemplary configuration of how end devices belonging to different VLANs and coupled to a TRILL network, wherein one RBridge is IP capable, in accordance with an embodiment of the present invention. In this example, a TRILL network 200 includes TRILL RBridges 220 and 230. End device 202 is coupled to RBridge 220 over VLAN 212, and end device 204 is coupled to RBridge 220 over VLAN 214.

In the example in FIG. 2A, RBridge 230 is IP capable and IP router 235 is the IP router portion of RBridge 230 (denoted in dotted line). IP router 235 functions as a default gateway router for end devices 202 and 204. Consequently, although RBridge 220 couples both end devices 202 and 204 to network 200, any traffic between end devices 202 and 204 will be routed via IP router 235 because end devices 202 and 204 belong to different VLANs. For example, if end device 202 sends a frame to end device 204, it first assembles an IP packet with end device 204's IP address. Based on its local forwarding table, end device 202 realizes that it does not have a direct route to end device 204, and therefore needs to send the packet to gateway router 235. Hence, end device 202 encapsulates the IP packet in an Ethernet frame, whose destination MAC address is set to be gateway router 235's MAC address. Note that, if end device 202 has no knowledge of IP router 235's MAC address, end device 202 can send out an ARP request corresponding to the IP address of router 235. Router 235 then replies to the ARP request with its MAC address. Subsequently, end device 202 forwards the frame to RBridge 230 via ingress RBridge 220. IP router 235, in turn, receives the frame and removes its leayer-2 header (including the VLAN tag corresponding to VLAN 212). IP router 235 then performs a lookup in its IP forwarding table based on the packet's destination IP address, and encapsulates the packet with a new Ethernet header which includes a VLAN tag corresponding VLAN 214. RBridge 230 then encapsulates the Ethernet frame with a TRILL header and forwards it to end device 204 via egress RBridge 220.

FIG. 2B illustrates an exemplary configuration of end devices belonging to different VLANs and coupled to a TRILL network, wherein all RBridges are IP capable, in accordance with an embodiment of the present invention. In this example, a TRILL network 200 includes TRILL RBridges 220 and 230. End device 202 is coupled to RBridge 220 over VLAN 212, and end device 204 is coupled to RBridge 220 over VLAN 214.

In the example in FIG. 2B, both RBridges 220 and 230 are IP capable and IP routers 225 and 235 are the IP router portion of RBridges 220 and 230, respectively. Under such a scenario, IP router 225 can be the default gateway router for end devices 202 and 204. Consequently, any traffic between end devices 202 and 204 can be routed via IP router 225. For example, if end device 202 sends a frame to end device 204, it assembles an IP packet with end device 204's IP address, encapsulates the IP packet in an Ethernet frame with destination MAC address as router 225's MAC address, and forwards the frame to RBridge 225 via ingress RBridge 220. Note that, if end device 202 has no knowledge of IP router 225's MAC address, end device 202 obtains the IP address of router 225 using ARP. IP router 225, in turn, receives the frame, performs a lookup in its IP forwarding table, encapsulates the packet with a new Ethernet header which includes a VLAN tag corresponding VLAN 214, and forwards it to end device 204 via egress RBridge 220. As the cross-layer-2-domain frame does not need to traverse through TRILL network 200, IP-processing capability at RBridge 220 thereby reduces the bandwidth usage in network 200.

### Distributed Layer-3 Processing

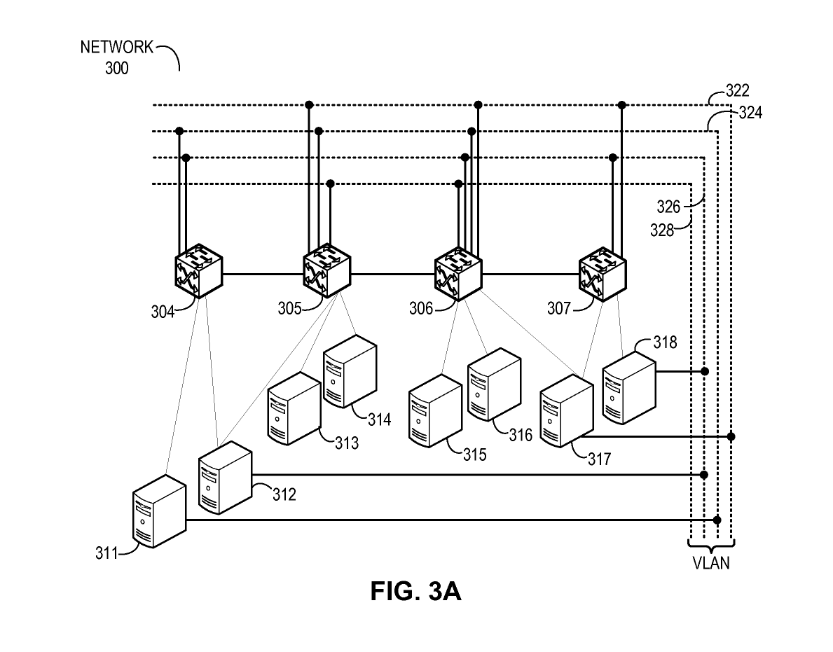

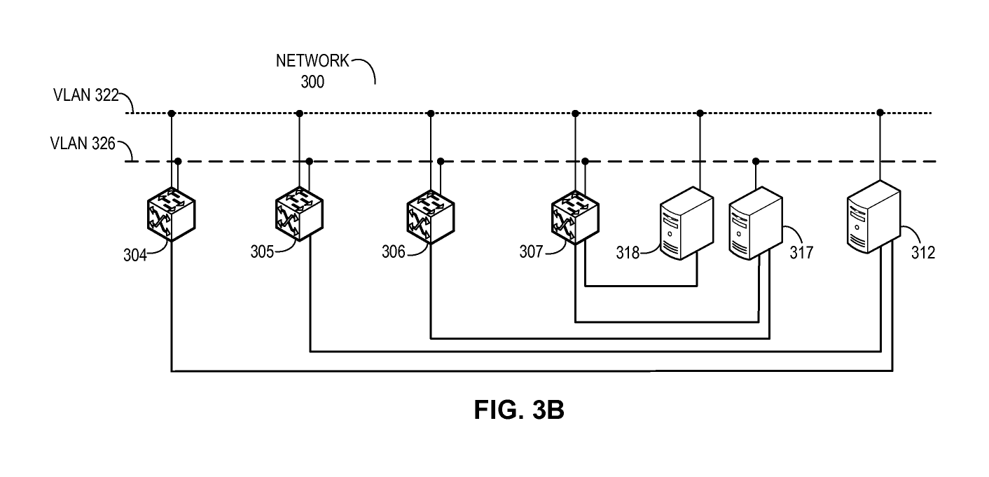

In some embodiments, layer-3 processing capabilities can be distributed to multiple or all TRILL RBridges. In some embodiments, layer-3 processing capabilities associated different the VLANs can be distributed selectively across multiple RBridges. FIG. 3A illustrates an exemplary TRILL network with multiple VLANs, in accordance with an embodiment of the present invention. In the example in FIG. 3A, network 300 includes RBridges 304, 305, 306, and 307. Each of these RBridges is IP capable. RBridge 304 is coupled to end devices 311 and 312; RBridge 305 is coupled to end devices 312, 313, and 314; RBridge 306 is coupled to end devices 315, 316, and 317; and RBridge 307 is coupled to end devices 317 and 318. RBridges 305 and 306 belong to VLAN 328; RBridges 304, 306, and 307, and end devices 312 and 318 belong to VLAN 326; RBridges 304, 305, and 306, and end device 311 belong to VLAN 324; and RBridges 305, 306, and 307, and end device 317 belong to VLAN 322.

In some embodiments, a layer-3 interface on an RBridge corresponding to a VLAN is a Switch Virtual Interface (SVI). For example, RBridge 304 in FIG. 3A has SVIs for VLANs 324 and 326 (although these SVIs can be on the same physical interface). Consequently, RBridge 304 and end device 318, and RBridge 304 and end device 311, are on the same VLAN segment. If end device 311 sends a frame to end device 318, the destination is outside of VLAN 324. Consequently, end device 318 sets the destination MAC address of the frame as the MAC address of the SVI on VLAN 324 at RBridge 304, which is the layer-3 gateway on VLAN 324. End device 318 then forwards the frame to RBridge 304. Upon receiving the frame, RBridge 304 recognizes that the frame's destination MAC address is a local MAC address. RBridge 304 then removes the frame's Ethernet header, performs a lookup in its IP forwarding table based on the frame's destination IP address, and encapsulates the frame with a new Ethernet header with a destination MAC address corresponding to end device 318 in VLAN 326. Finally, RBridge 304 forwards the frame to end device 318 via egress RBridge 307.

However, when end device 311 sends a frame to end device 317, RBridge 304 cannot forward the frame to end device 317 because RBridge 304 does not have an SVI on VLAN 322, to which end device 317 belongs. As a result, upon receiving a frame destined to end device 317 from end device 311, RBridge encapsulates the frame using a TRILL header with egress RBridge identifier corresponding to RBridge 306 because it has SVIs to all VLANs. RBridge 304 then forwards the frame to RBridge 306. The frame is routed though the TRILL network and reaches RBridge 306 when the outer destination MAC addresses match the MAC address of RBridge 306. Upon receiving the frame, RBridge 306 recognizes that the frame's outer destination MAC address is a local MAC address. RBridge 306 then removes the TRILL encapsulations, encapsulates the IP packet with a new Ethernet header with a destination MAC address corresponding to end device 317 in VLAN 322, and forwards the frame accordingly.

FIG. 3B illustrates an exemplary TRILL network with multiple VLANs, wherein each RBridge belongs to all VLANs, in accordance with an embodiment of the present invention. In this example, TRILL network 300 includes RBridges 304, 305, 306, and 307. Each of these RBridges is IP capable. End device 312 is coupled to RBridges 304 and 305, end device 317 is coupled to RBridges 306 and 307, and end device 318 is coupled to RBridge 307. All RBridges in network 300 have SVIs for VLANs 322 and 326. End devices 312 and 318 belong to VLAN 322, and end device 317 belongs to VLAN 326.

In this example, if end device 317 sends a frame to end device 318, the frame can be routed on layer-3 at RBridge 307 because RBridge 307 has SVIs for VLANs 322 and 326. As the frame does not travel to any other RBridge in network 300, it incurs lower latency while saving bandwidth in network 300. Similarly, if end device 317 sends a frame to end device 312, the frame can be routed on layer-3 at the IP router portion of either RBridge 306 or 307 as both have SVIs for VLANs 322 and 326. If all RBridges in the TRILL network have SVIs for all VLANs, inter-VLAN switching is possible at each RBridge.

### Frame Processing

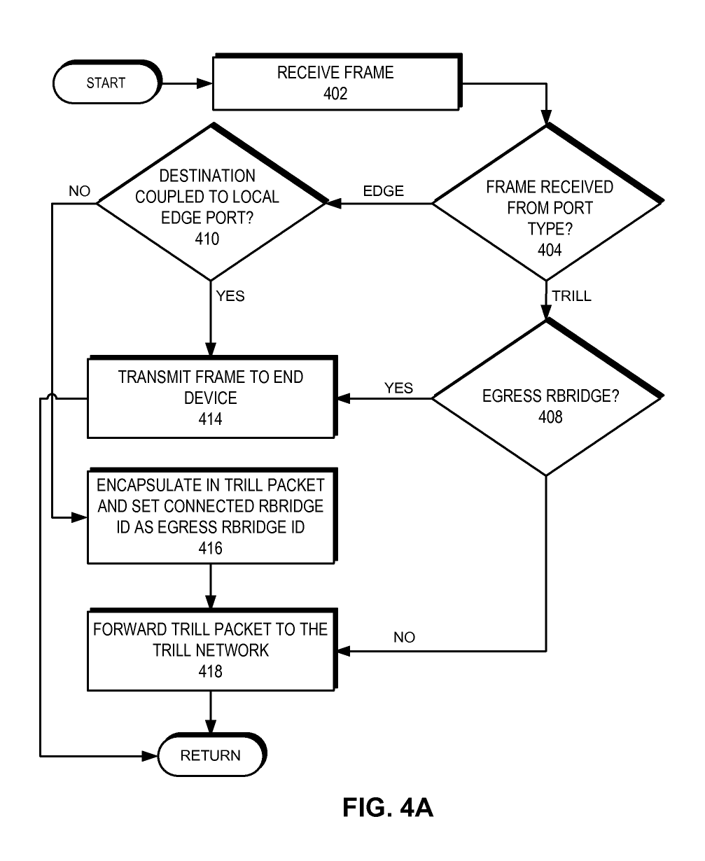

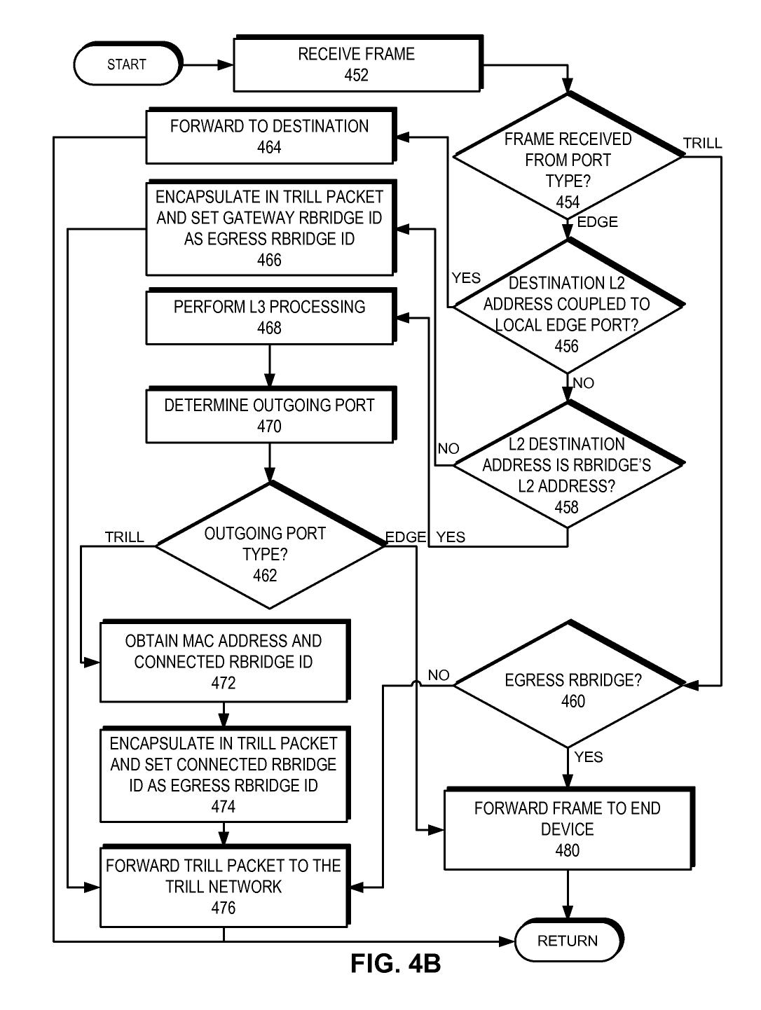

FIG. 4A presents a flowchart illustrating the process of an RBridge transmitting a frame, in accordance with an embodiment of the present invention. During operation, an RBridge receives a frame (operation 402) and determines the type of port at which the frame was received (operation 404). If the frame is received at an edge port, then the RBridge checks whether the destination is coupled to a local edge port (operation 410). If the destination is not coupled to a local edge port, the RBridge encapsulates the frame in a TRILL packet and sets the RBridge identifier of the RBridge to which the end device is coupled as the egress RBridge identifier (operation 416). The RBridge then forwards the TRILL packet to the TRILL network (operation 418). Note that the MAC learning process allows an RBridge to learn about the port to which the end device is coupled.

If the frame is received on an edge port and the destination is coupled to a local edge port (operation 410), then the RBridge transmits the frame to the destination end device coupled to a local edge port (operation 414).

If the frame is received from a TRILL port (operation 404), the RBridge checks whether itself is the egress RBridge of the TRILL packet (operation 408). If not, then the RBridge forwards the TRILL packet to the TRILL network (operation 418). Otherwise, the RBridge transmits the frame to the destination end device coupled to a local edge port (operation 414).

FIG. 4B presents a flowchart illustrating the process of an IP-capable RBridge transmitting a frame, in accordance with an embodiment of the present invention. The exemplary process in FIG. 4B is also applicable to embodiments with distributed layer-3 processing, as described in conjunction with FIG. 3A. During operation, an RBridge receives a frame (operation 452) and determines the type of port at which the frame is received (operation 454). If the frame is received at an edge port, then the RBridge inspects the frame to determine whether the end device with the destination MAC address is coupled to a local edge port (operation 456). If so, the frame is forwarded to the destination via the TRILL network (operation 464), as described in conjunction with FIG. 4A.

If the frame's destination MAC address is not coupled to a local edge port, then the RBridge determines whether the frame's destination MAC address is the RBridge's MAC address (operation 458). If the destination MAC address is not the RBridge's MAC address, then the RBridge encapsulates the frame in a TRILL packet and sets the RBridge identifier of a gateway RBridge as the egress RBridge identifier (operation 466). The RBridge then forwards the TRILL packet to the TRILL network (operation 476). On the other hand, if the frame's destination MAC address is the RBridge's MAC address (operation 458), then the RBridge performs layer-3 processing on the frame (operation 468) and determines the outgoing port (operation 470).

The RBridge then determines the type of the outgoing port (operation 462). If the outgoing port is an edge port, which means the destination end device is coupled locally, the RBridge forwards the frame, which is Ethernet encapsulated with the end device's MAC address as the destination MAC address, to the destination end device (operation 480). In some embodiments, the end device can be a layer-3 (e.g., IP) router. If the outgoing port is a TRILL port, then the end device is connected to a remote RBridge. Hence, the RBridge obtains the

RBridge identifier of the RBridge to which the destination end device is coupled to based on the MAC address of the destination end device (operation 472). The RBridge then encapsulates the frame in a TRILL packet and sets the obtained RBridge identifier as the egress RBridge identifier (operation 474). The RBridge then forwards the TRILL packet to the TRILL network (operation 476).

If the frame is received from a TRILL port (operation 454), the RBridge checks whether itself is the egress RBridge of the TRILL packet (operation 460). If not, then the RBridge forwards the TRILL packet to the TRILL network (operation 476). Otherwise, the RBridge forwards the frame to the destination end device coupled to a local edge port (operation 480). In some embodiments, the end device can be a layer-3 router, in which case the forwarding includes layer-3 processing on the frame.

### Virtual Switch Formation

In some embodiments, a number of TRILL RBridges with IP processing capabilities may act as layer-3 routers for an end device. These RBridges can form a virtual RBridge, which is assigned with a virtual RBridge identifier. Furthermore, these RBridges form a virtual IP router, which is assigned with a virtual IP address and a corresponding virtual MAC address. This virtual IP router operates as a default gateway router, which can provide redundancy and load balancing.

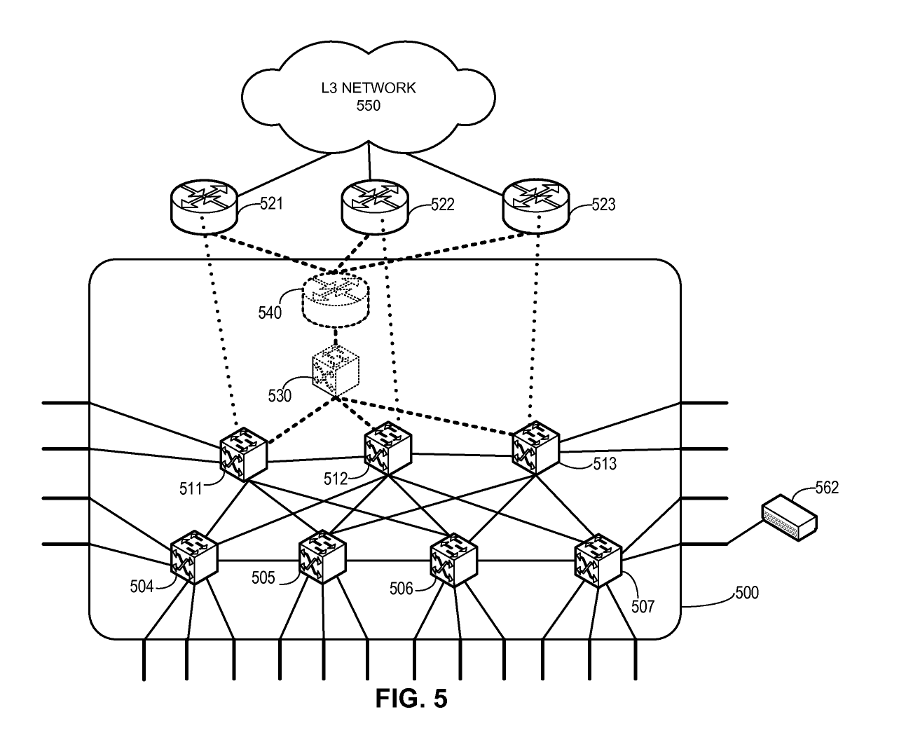

FIG. 5 illustrates an exemplary network where a virtual RBridge and an associated virtual IP router are created based on a plurality of physical gateway RBridges with IP processing capabilities, in accordance with an embodiment of the present invention. As illustrated in FIG. 5, a TRILL network 500 includes RBridges 504, 505, 506, 507, 511, 512, and 513. RBridges 511, 512, and 513 operate as gateway RBridges and are coupled to a layer-3 network 150 as IP routers 521, 522, and 523, respectively. For example, gateway RBridge 511 and IP router 521 are same physical device (represented by dotted lines), where its TRILL RBridge portion is denoted by gateway RBridge 511 and its IP router portion is denoted by IP router 521. Similarly, gateway RBridge 512 and IP router 522, and gateway RBridge 513 and IP router 523 are the same physical devices, respectively.

Gateway RBridges 511, 512, and 513 form a virtual RBridge 530 by operating as a single logical RBridge in TRILL network 500. Similarly, the corresponding IP routers 521, 522, and 523 form a virtual IP router 540 by operating as a single logical IP router. An end device 562 coupled to network 500 through RBridge 507 can use virtual IP router 540 as the default gateway router to layer-3 network 550.

In embodiments of the present invention, as illustrated in FIG. 1, Virtual RBridge 530 is considered to be logically coupled to gateway RBridges 511, 512, and 513, optionally with zero-cost links represented by dashed lines. Furthermore, gateway RBridges 511, 512, and 513 can advertise their respective connectivity (optionally via zero-cost links) to virtual RBridge 530. As a result, other RBridges in the TRILL network can learn that virtual RBridge 530 is reachable via gateway RBridges 511, 512, and 513, and establish TRILL paths to virtual RBridge 530 using a corresponding virtual RBridge identifier through these gateway RBridges.

All the IP-layer router portions of these gateway RBridges are configured to operate as the layer-3 gateway router (i.e., virtual IP router 540) for end device 562. End device 562 uses virtual IP router 540 as the default gateway. Because virtual RBridge 530 is associated with virtual IP router 540, incoming frames from end device 562 destined to network 550 are marked with virtual RBridge 530's identifier as the egress RBridge identifier. Consequently, all frames from end device 562 to network 550 are delivered to one of the gateway RBridges 511, 512, and 513. Hence, load balancing can be achieved among gateway RBridges 511, 512, and 513 for frames sent to virtual RBridge 530.

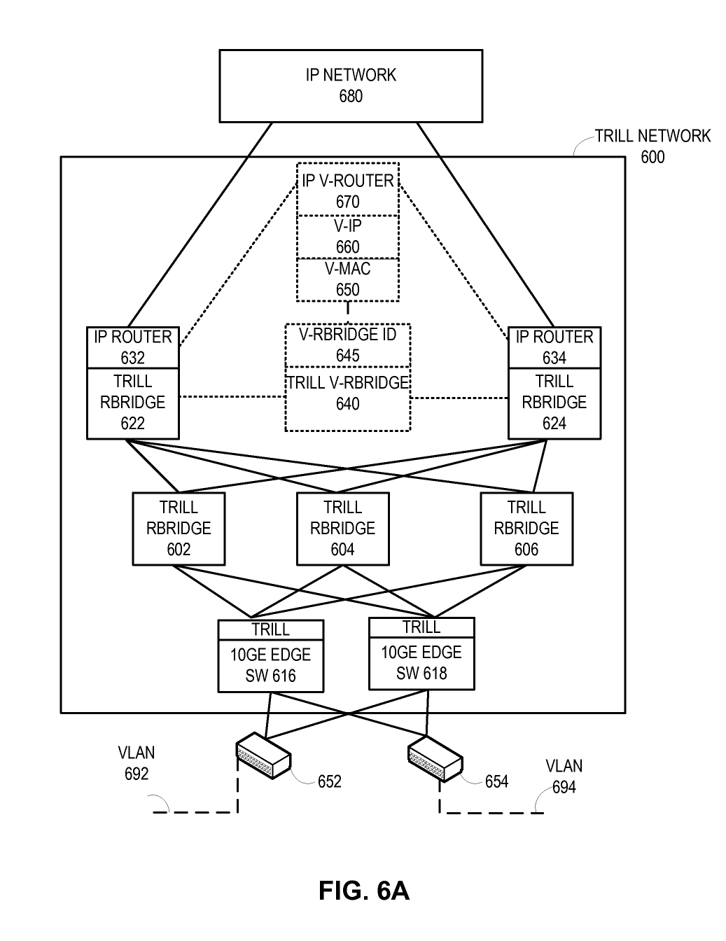

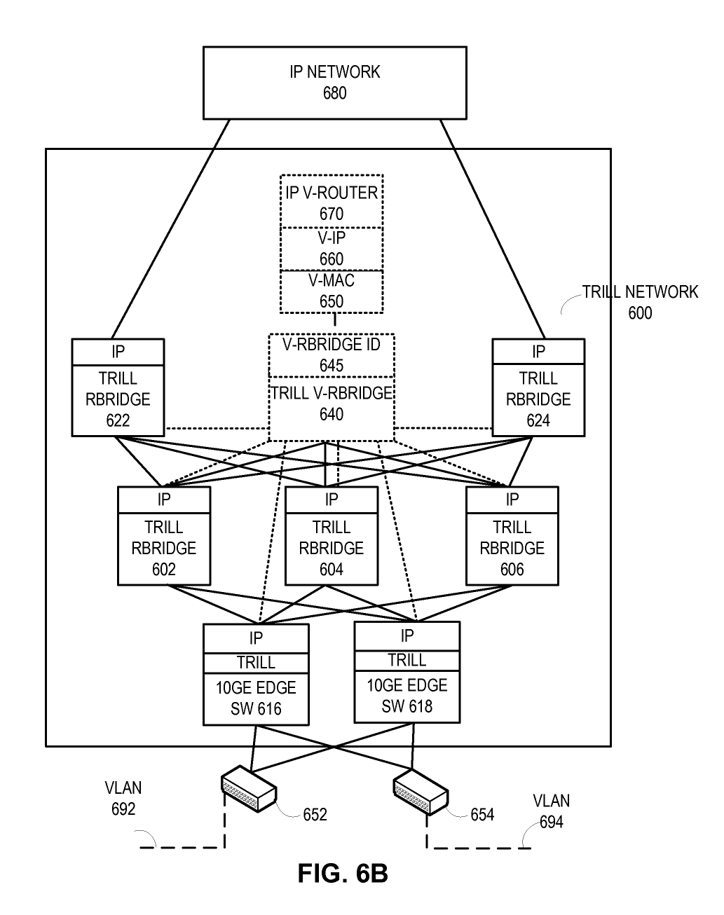

FIG. 6A illustrates an exemplary configuration of how a virtual RBridge and an associated virtual IP router can be logically coupled to a number of gateway RBridges in a TRILL network, in accordance with an embodiment of the present invention. In this example, a TRILL network 600 includes a number of TRILL RBridges 602, 604, and 606. Network 600 also includes RBridges 616 and 618, each with a number of edge ports which can be coupled to external networks. For example, RBridges 616 and 618 are coupled with end devices 652 and 654 via 10GE edge ports. RBridges in network 600 are in communication with each other using TRILL protocol.

Also included in network 600 are RBridges 622 and 624, which are layer-3 capable and coupled to an IP network 680. Gateway RBridges 622 and 624 form virtual RBridge 640 with a virtual RBridge identifier 645. Physically co-located IP Routers 632 and 634 within gateway RBridges 622 and 624, respectively, form a virtual IP router 670 which is assigned a virtual IP address 660 and a virtual MAC address 650. Virtual IP address 660 maps to virtual MAC address 650 for ARP requests directed to virtual IP router 670. Furthermore, virtual RBridge identifier 645 is associated with virtual MAC address 650. End devices 652 and 654 can set virtual IP address 660 as their default gateway router address and use ARP to obtain virtual MAC address 650. End devices 652 and 654 send frames with virtual MAC address 650 as the destination address into network 600. The frames are encapsulated in TRILL packets and routed toward virtual RBridge 640 using the corresponding virtual RBridge identifier 645.

In some embodiments, a virtual IP address can be assigned for each VLAN associated with a TRILL network. For example, in FIG. 6A, end device 652 may belong to VLAN 692, and end device 654 may belong to VLAN 694. Different virtual IP addresses may be used for VLANs 692 and 694, respectively. End devices 652 and 654 then use the virtual IP address associated with VLAN 692 and VLAN 694 as their respective default gateway router addresses. Consequently, end devices 652 and 654 perceive virtual IP router 670 to be in VLAN 692 and VLAN 694, respectively. For ARP requests for either virtual IP address, the same virtual MAC address 650 is sent in reply. All data frames injected to TRILL network 600 with virtual MAC address 650 as the destination MAC address are routed toward virtual RBridge 640.

Note that in one embodiment, the virtual MAC address is known to all RBridges in the network 600. Otherwise, both IP routers 632 and 634 receive a frame forwarded to virtual MAC address 650 and results in packet duplication. Hence, after formation of virtual RBridge 640 and virtual IP router 670, all RBridges in network 600 are provided with the knowledge about virtual MAC address 650. That is, virtual MAC address 650 is always “known” to all ingress RBridges in network 600, and frames destined to virtual MAC address 650 are routed through network 600 using TRILL unicast.

In some embodiments, only one gateway RBridge is elected to reply to ARP requests for the virtual IP address. This election can also be VLAN specific.

FIG. 6B illustrates an exemplary configuration of how a virtual RBridge and an associated virtual IP router can be logically coupled to all RBridges in a TRILL network where each RBridge has IP processing capability, in accordance with an embodiment of the present invention. In this example, all RBridges in TRILL network 600 have IP processing capabilities. Even though only RBridges 622 and 624 are connected to an IP network, IP processing capacity at all RBridges enables them to route across VLANs, as described in conjunction with FIG. 3B. For example, any traffic between VLANs 692 and 694 can be switched at RBridges 616 and 618 without requiring the traffic to travel to another RBridge in network 600.

In some embodiments, all RBridges in network 600 are associated with virtual RBridge 640 and a virtual IP router 670, and share a virtual RBridge identifier 645, a virtual IP address 660, and a virtual MAC address 650. In some embodiments, all RBridges in network 600 may be connected to IP network 680.

### ARP and Frame Processing in a Virtual Switch

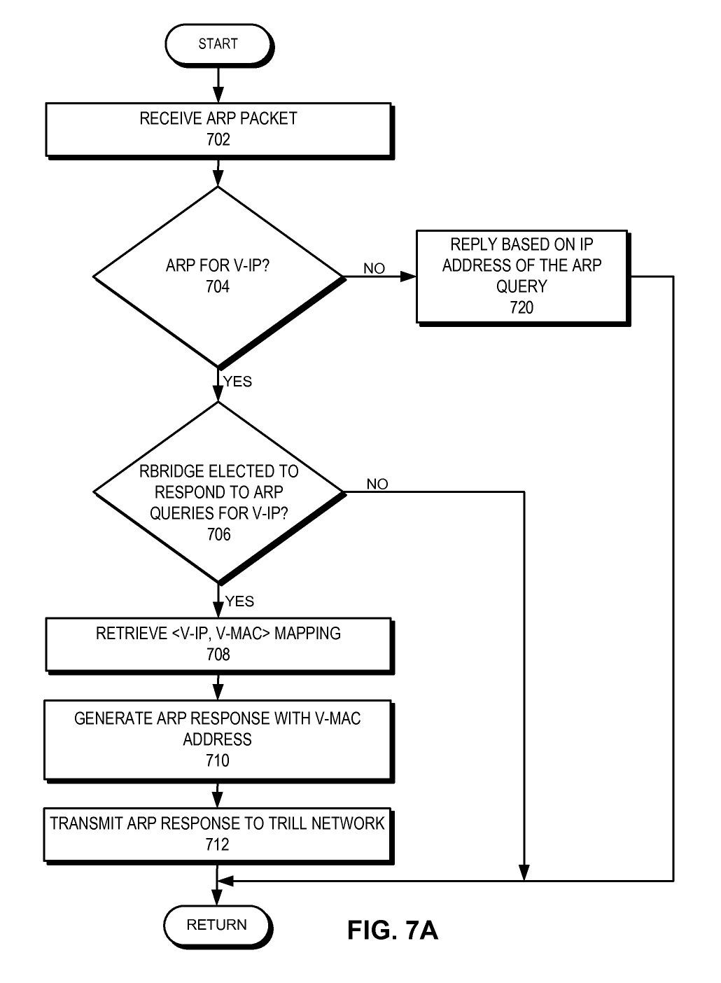

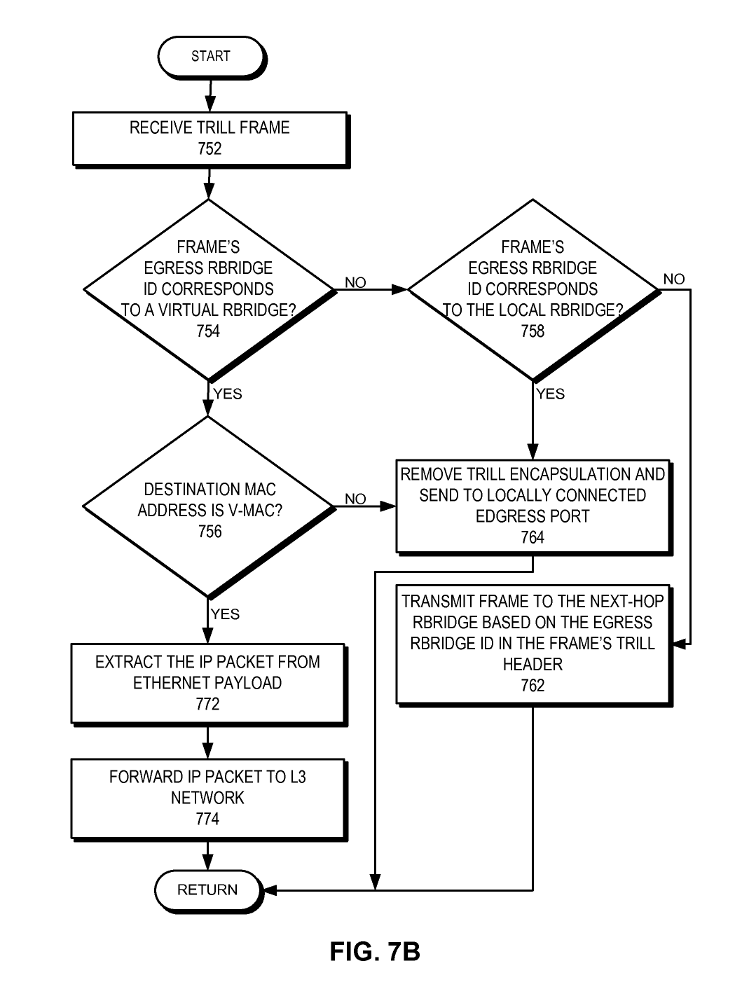

FIG. 7A presents a flowchart illustrating the process of a gateway RBridge associated with a virtual RBridge responding to an Address Resolution Protocol (ARP) query, in accordance with an embodiment of the present invention. Upon receiving an ARP request packet for an IP address (operation 702), the gateway RBridge checks whether the ARP request is for a virtual IP address (operation 704). If not, the gateway RBridge responds based on the IP address in the ARP request (assuming that IP address is the gateway RBridge's physical IP address) (operation 720). Otherwise, the gateway RBridge checks whether it is elected to respond to an ARP request for the virtual IP address (operation 706). If not, the ARP request is discarded. Otherwise the gateway RBridge retrieves the virtual MAC address for the virtual IP address (operation 708) and generates an ARP reply containing the virtual MAC address (operation 710). The gateway RBridge transmits the ARP reply to the TRILL network (operation 712). Note that an ARP request is disseminated in the TRILL network using multicast and each IP-capable RBridge, including the one elected to respond to ARP requests for the virtual IP address, receives the query. However, the ARP reply is sent as a unicast transmission in the TRILL network to the end device.

FIG. 7B presents a flowchart illustrating the process of a gateway RBridge associated with a virtual RBridge forwarding a TRILL frame, in accordance with an embodiment of the present invention. Upon receiving a TRILL frame (operation 752), the RBridge checks whether the egress RBridge identifier in the TRILL header of the frame corresponds to a virtual RBridge (operation 754). If the identifier does not correspond to the virtual RBridge, the RBridge inspects whether the egress RBridge identifier in the TRILL header of the frame corresponds to the local RBridge. If not, then the TRILL frame is forwarded to the next-hop RBridge based on the egress RBridge identifier (operation 762). Otherwise, the RBridge removes the TRILL encapsulation and send the frame to a local egress port (operation 764). If the RBridge identifier corresponds to the virtual RBridge, the RBridge checks whether the destination MAC address of the Ethernet frame encapsulated in the TRILL frame is the associated virtual MAC address (operation 756). If so, then the frame is destined to an IP network the gateway RBridge is coupled to. Hence, the IP packet is extracted from the Ethernet payload of the frame (operation 772). The gateway RBridge checks the IP address of the IP packet and performs layer-3 IP forwarding toward the IP network (operation 774). On the other hand, if the destination MAC address is not the virtual MAC address, then the virtual RBridge is for multi-homed layer-2 end devices. Accordingly, the RBridge removes the TRILL encapsulation and send the frame to locally connected egress port (operation 764). Operation of virtual RBridges for multi-homed end devices, such as forwarding multicast frames, is specified in the U.S. Patent Publication No. 2010/0246388, titled “Redundant Host Connection in a Routed Network,” the disclosure of which is incorporated herein in its entirety.

### Failure Handling

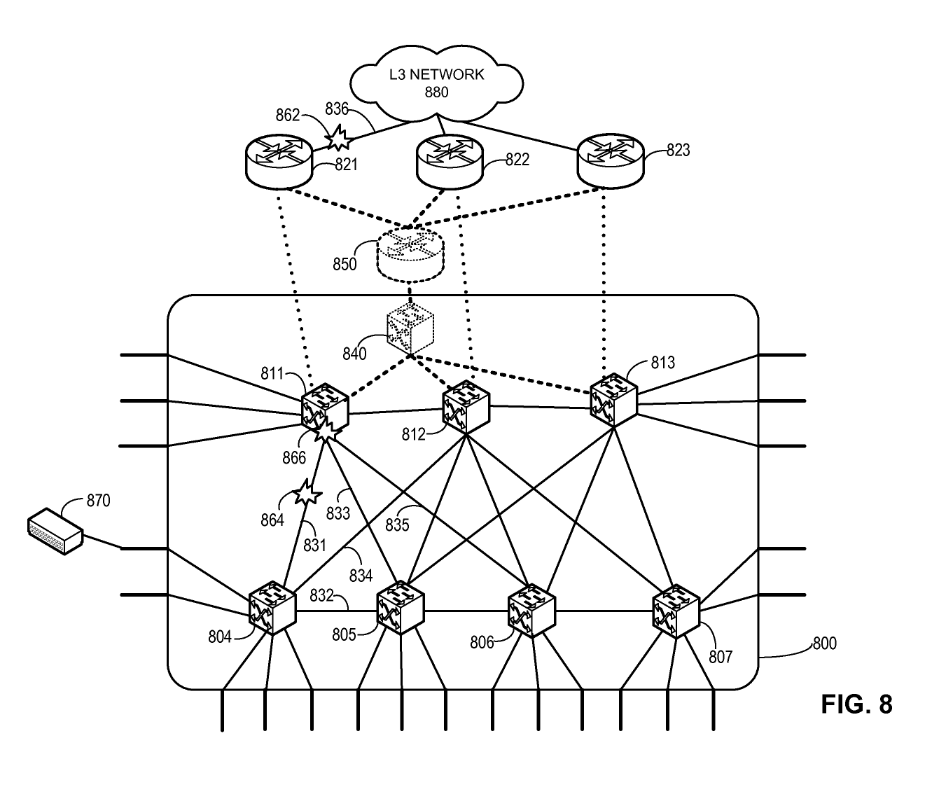

FIG. 8 illustrates a scenario where one of the RBridges associated with the virtual RBridge experiences a link failure and/or a node failure, in accordance with an embodiment of the present invention. In this example, in a TRILL network 800, RBridges 811, 812, and 813 form a virtual RBridge 840, and their respective IP-router portions denoted as IP routers 821, 822, and 823 form a virtual IP router 850. Also included are four RBridges 804, 805, 806, and 807. An end device 870 is connected to network 800 using RBridge 804 as the ingress RBridge. Virtual IP router 850 is set as a default gateway router for end device 870. Hence, all frames destined to network 880 from end device 870 have the virtual MAC address assigned to virtual IP router 850 as the destination MAC address. Note that these frames can be forwarded by gateway RBridges 811, 812, and 813 for load balancing. Gateway RBridges 811, 812, and 813 also provide redundancy among each other to handle failures.

Suppose that a failure 864 occurs to link 831 adjacent to gateway RBridge 811. As a result, link 831 is removed from routing decisions in network 800. All frames from end device 870 are still using the virtual MAC address as the destination address, and thus are still forwarded to any of the gateway RBridges via alternative links (e.g., links 832, 833, and 834).

Suppose that a failure 862 occurs during operation that fails link 836 adjacent to IP router 821. Consequently, IP router 821 is disconnected from network 880 and is incapable of forwarding frames to network 880. Under such a scenario, IP router 821 is removed from virtual IP router 850. As a result, IP router 821 stops operating as a layer-3 gateway router for end device 870. However, gateway RBridge 811 still remains connected to network 800 and continues to operate as a regular TRILL RBridge. As virtual IP router 850 still operates as a default gateway for end device 870, IP routers 822 and 823 can continue to operate as layer-3 gateway routers (as virtual IP router 850) for end device 870. Hence, all frames from end device 870 to network 880 are then distributed among gateway RBridges 812 and 813.

In some embodiments, with failure 862, an elected gateway RBridge stops responding to ARP requests for the virtual IP address and notifies other gateway RBridges. Consequently, the other gateway RBridges then elect among themselves another gateway RBridge to respond to ARP requests.

In some embodiments, with failure 862, IP router 821 might not immediately remove its membership from virtual IP router 850 and might continue to receive layer-3 traffic from end devices. Under such circumstances, gateway RBridge 811, the TRILL counterpart of IP router 821, forwards the layer-3 traffic with TRILL encapsulation to other gateway RBridges (e.g., gateway RBridge 812) which, in turn, forward the traffic to network 880. However, if all similar IP routers suffer link failures and lose their connection to network 880, IP router 821 along with the other gateway RBridges with link failures are removed from virtual IP router 850. However, all gateway RBridges continue operating as TRILL RBridges.

Suppose that a node failure 866 occurs at gateway RBridge 811 (and essentially IP router 821 as they are the same physical device). As a result, links 831, 833, 835, and 836 fail as well. Consequently, gateway RBridge 811 and IP router 821 are disconnected from both network 800 and network 880, and are incapable of transmitting to or receiving from either network. Under such a scenario, IP router 821 is removed from virtual IP router 850 and gateway RBridge 811 is removed from virtual RBridge 840. As a result, IP router 821 stops operating as a layer-3 gateway node. Furthermore, gateway RBridge 811 is disconnected from network 800 and removed from all TRILL routes in network 800.

With failure 866, as virtual IP router 850 still operates as a default gateway for end device 870, routers 822 and 823 continue operating as layer-3 gateway nodes for end device 870. Hence, all frames from end device 870 to network 880 are distributed between gateway RBridges 812 and 813. Furthermore, if IP router 821 had been an elected router, it stops responding to ARP requests for the virtual IP address. Other RBridges coupled to the failed gateway RBridge can detect the failure and notify all RBridges, including other active gateway RBridges. Consequently, the active gateway RBridges can elect another gateway RBridge to respond to ARP requests.

### Exemplary Switch System

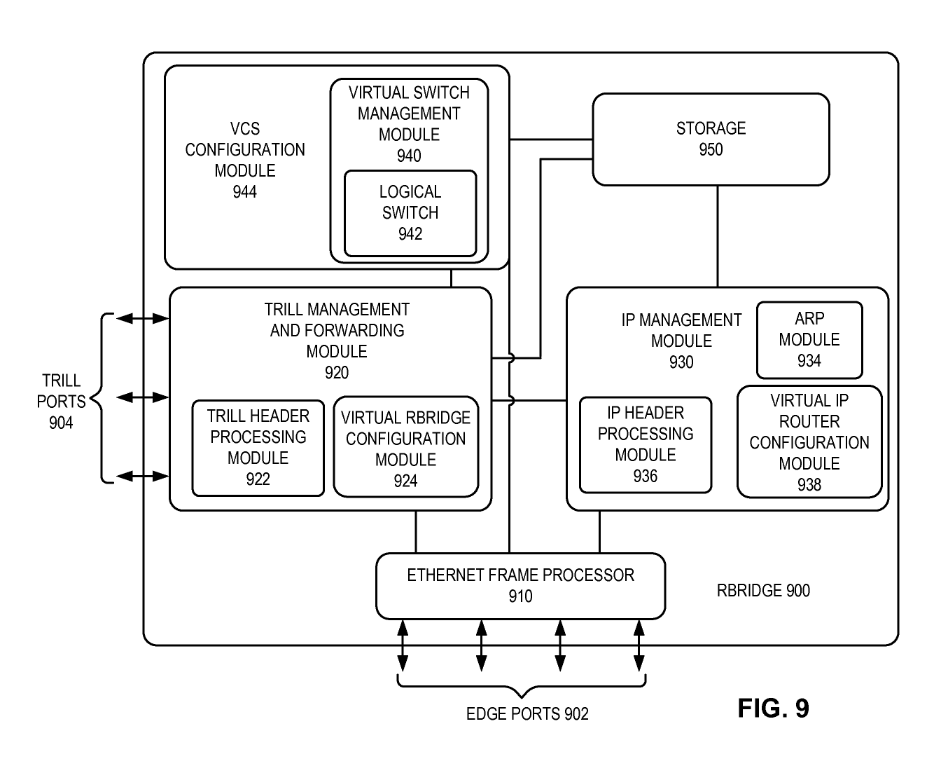

FIG. 9 illustrates an exemplary architecture of a switch with IP processing capabilities, in accordance with an embodiment of the present invention. In this example, an RBridge 900 includes a number of TRILL ports 904, a TRILL management and forwarding module 920, an IP management module 930, an Ethernet frame processor 910, and a storage 950. TRILL management and forwarding module 920 further includes a TRILL header processing module 922. IP management module 930 further includes an ARP module 934 and an IP header processing module 936.

TRILL ports 904 include inter-switch communication channels for communication with one or more RBridges. This inter-switch communication channel can be implemented via a regular communication port and based on any open or proprietary format. Furthermore, the inter-switch communication between RBridges is not required to be direct port-to-port communication.

During operation, TRILL ports 904 receive TRILL frames from (and transmit frames to) other RBridges. TRILL header processing module 922 processes TRILL header information of the received frames and performs routing on the received frames based on their TRILL headers, as described in conjunction with FIG. 4B. TRILL management and forwarding module 920 forwards frames in the TRILL network toward other RBridges and frames destined to a layer-3 node toward the IP management module 930. IP header processing module 936 forwards frames across VLANs.

In some embodiments, RBridge 900 may form a virtual RBridge and a virtual IP address, wherein TRILL management and forwarding module 920 further includes a virtual RBridge configuration module 924, and IP management module 930 further includes a virtual IP router configuration module 938. TRILL header processing module 922 generates the TRILL header and outer Ethernet header for ingress frames corresponding to the virtual RBridge. Virtual RBridge configuration module 924 manages the communication with gateway RBridges and handles various inter-switch communications, such as link and node failure notifications. Virtual RBridge configuration module 924 allows a user to configure and assign the identifier for the virtual RBridges, and decides whether a frame has to be promoted to layer-3, as described in conjunction with FIG. 7B.

Furthermore, virtual IP router configuration module 938 handles various inter-switch communications, such as layer-3 link failure notifications. Virtual IP router configuration module 938 allows a user to configure and assign virtual IP addresses and a virtual MAC address.

ARP module 934 is responsible for ARP request replies, as described in conjunction with FIG. 4B. ARP module 934 also maintains mappings between a virtual MAC address and a virtual IP address and stores the mappings in Storage 950. Storage 950 also includes TRILL and IP routing information.

In some embodiments, gateway RBridge 900 may include a number of edge ports 902, as described in conjunction with FIG. 1. Edge ports 902 receive frames from (and transmit frames to) end devices. Ethernet frame processor 910 extracts and processes header information from the received frames. Ethernet frame processor 910 forwards the frames to IP management module 930 if there is no other intermediate RBridge between the end device and RBridge 900.

In some embodiments, gateway RBridge 900 may include a VCS configuration module 944 that includes a virtual switch management module 940 and a logical switch 942 as described in conjunction with FIG. 1. VCS configuration module 944 maintains a configuration database in storage 950 that maintains the configuration state of every switch within the VCS. Virtual switch management module 940 maintains the state of logical switch 942, which is used to join other VCS switches. In some embodiments, logical switch 942 can be configured to operate in conjunction with Ethernet frame processor 910 as a logical Ethernet switch.

Note that the above-mentioned modules can be implemented in hardware as well as in software. In one embodiment, these modules can be embodied in computer-executable instructions stored in a memory which is coupled to one or more processors in gateway RBridge 900. When executed, these instructions cause the processor(s) to perform the aforementioned functions.

In summary, embodiments of the present invention provide a switch, a method and a system for providing layer-3 support in a TRILL network. In one embodiment, the switch includes an IP header processor and a forwarding mechanism. The IP header processor identifies a destination IP address in a packet encapsulated with an inner Ethernet header, a TRILL header, and an outer Ethernet header. The forwarding mechanism determines an output port and constructs a new header for the packet based on the destination IP address. The switch also includes a packet processor which determines whether (1) an inner destination media access control (MAC) address corresponds to a local MAC address assigned to the switch; (2) a destination RBridge identifier corresponds to a local RBridge identifier assigned to the switch; and (3) an outer destination MAC address corresponds to the local MAC address. Such configuration provides a scalable and flexible solution to enable layer-3 processing in the switch.

The methods and processes described herein can be embodied as code and/or data, which can be stored in a computer-readable non-transitory storage medium. When a computer system reads and executes the code and/or data stored on the computer-readable non-transitory storage medium, the computer system performs the methods and processes embodied as data structures and code and stored within the medium.

The methods and processes described herein can be executed by and/or included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of embodiments of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A switch, comprising:
an Internet Protocol (IP) header processor configured to identify a destination IP address in a packet encapsulated with an inner Ethernet header, a Transparent Interconnection of Lots of Links (TRILL) header, and an outer Ethernet header;
a packet processor configured to determine that:
an inner destination media access control (MAC) address corresponds to a local MAC address assigned to the switch;
a destination routing bridge (RBridge) identifier corresponds to local RBridge identifier assigned to the switch; and
an outer destination MAC address corresponds to the local MAC address;
and
a forwarding mechanism configured to determine an output port and construct a new header for the packet based on the destination IP address.

2. The switch of claim 1, wherein the packet processor is further configured to determine a first virtual local area network (VLAN) tag in the inner Ethernet header; and
wherein the new header includes a new inner Ethernet header which comprises a second VLAN tag.

3. The switch of claim 1, further comprising a control mechanism configured to form a virtual cluster switch in conjunction with one or more additional switches.

4. The switch of claim 3, wherein the virtual cluster switch is an Ethernet fabric switch functioning as a logical Ethernet switch.

5. The switch of claim 1, further comprising a switching mechanism configured to switch the packet between VLANs based on the destination IP address.

6. The switch of claim 1, wherein the RBridge identifier is a virtual RBridge identifier; and
wherein the destination IP address is a virtual IP address assigned to a virtual IP router associated with the virtual RBridge identifier.

7. The switch of claim 6, wherein the virtual IP router is formed based on the switch in conjunction with at least another physical switch and operates as a single logical router.

8. A method, comprising:
identifying a destination IP address in a packet encapsulated with an inner Ethernet header, a TRILL header, and an outer Ethernet header;
determining that:
an inner destination MAC address corresponds to a local MAC address assigned to a switch;
a destination RBridge identifier corresponds to a local RBridge identifier assigned to the switch; and
an outer destination MAC address corresponds to the local MAC address;
determining an output port; and
constructing a new header for the packet based on the destination IP address.

9. The method of claim 8, further comprising determining a first VLAN tag in the inner Ethernet header; and
including in the new header a new inner Ethernet header which comprises a second VLAN tag.

10. The method of claim 8, further comprising forming a virtual cluster switch in conjunction with one or more additional switches.

11. The method of claim 10, wherein the virtual cluster switch is an Ethernet fabric switch functioning as a logical Ethernet switch.

12. The method of claim 8, further comprising switching the packet between VLANs based on the destination IP address.

13. The method of claim 8, wherein the RBridge identifier is a virtual RBridge identifier; and
wherein the destination IP address is a virtual IP address assigned to a virtual IP router associated with the virtual RBridge identifier.

14. The method of claim 13, further comprising forming the virtual IP router by operating the switch in conjunction with at least another physical switch as a single logical router.

15. A system, comprising:
a first RBridge with IP processing capability and is associated with a first VLAN and a second VLAN; and
a second RBridge associated with the first VLAN;
wherein the second RBridge comprises a forwarding mechanism configured to forward a packet from the second RBridge to the first RBridge, wherein the packet is originated from the first VLAN and destined to the second VLAN; and
wherein the first RBridge comprises a switching mechanism configured to switch the packet between the first VLAN and the second VLAN based on the destination IP address.

16. The system of claim 15, within the first RBridge comprises a packet processor configured to determine that:
an inner destination MAC address corresponds to a local MAC address assigned to the first RBridge;
a destination RBridge identifier corresponds to a local RBridge identifier assigned to the first RBridge; and
an outer destination MAC address corresponds to the local MAC address.

17. The system of claim 15, wherein the first and second RBridges form a virtual cluster switch.

18. The system of claim 17, wherein the virtual cluster switch is an Ethernet fabric switch functioning as a logical Ethernet switch.

19. The system of claim 16, further comprising:
a virtual RBridge formed based on a number of RBridges functioning as a single logical RBridge, wherein the virtual RBridge is associated with a virtual identifier; and
a virtual IP router formed based on a number of RBridges with active IP processing capabilities functioning as a single logical IP router, wherein the virtual IP router is associated with a virtual IP address.

20. The system of claim 15, wherein the first RBridge is configured as a gateway router.
